(19) United States
(12) Patent Application Publication
(10) Pub. No.: US 2007/0036908 A1
(43) Pub. Date: Feb. 15, 2007

(54) Method and device for melt dip coating metal strips, especially steel strips

(76) Inventors: Holger Behrens, Erkrath (DE); Rolf Brisberger, Issum (DE); Bodo Falkenhahn, Ratingen (DE); Hans Georg Hartung, Pulheim (DE); Bernhard Tenckhoff, Duisburg (DE); Walter Trakowski, Duisburg (DE); Michael Zielenbach, Siegen (DE)

Correspondence Address: FRIEDRICH KUEFFNER, 317 MADISON AVENUE, SUITE 910, NEW YORK, NY, 10017, US

(21) Appl. No.: 10/547,215

(22) PCT Filed: Feb. 13, 2004
(86) PCT No.: PCT/EP04/01341

§ 371 Date: Oct. 10, 2006

(30) Foreign Application Priority Data
Feb. 27, 2003 (DE) 103 08 834.2
Mar. 22, 2003 (DE) 103 12 939.1

(51) Int. Cl. B05D 1/18; B05C 3/12

(52) U.S. Cl. 427/431; 427/532; 118/420; 118/423

(57) ABSTRACT

The invention relates to a method for melt dip coating a metal strip (1), especially a steel strip (1a), which is guided through a coating station (4). The metal strip (1) is coated with a coating metal (3), the metal strip (1) is centrally maintained in a guide channel (8) in an electromagnetic sealing field (13) which seals the guide channel (8) from below and guides the metal strip (1) laterally, counter to ferromagnetic attraction, through a corrector field (14). The sealing field (13) is embodied as an electromagnetic guiding field (10), as a blocking field (11) or as a pump field (12) in order to select adequate lateral sealing when any particular sealing field (13) is used. Several corrector fields (14) are arranged in a distributed manner in a selected configuration, whereby the position and number thereof are determined individually at least according to the various widths of the metal strip (1).

The invention concerns a method and a device for hot dip coating metal strip, especially steel strip, wherein the strip is guided obliquely or vertically from bottom to top through the molten coating metal in a coating station, wherein the coating thickness is controlled after the strip has emerged from the coating bath, and wherein the thin metal strip, which has a tendency to vibrate, is sealed towards the bottom by an electromagnetic sealing field in the guide channel while the coating is still liquid and at a variable strip speed and is guided laterally by a correction field, which compensates for ferromagnetic attraction.

A method of this type and the corresponding device, especially the electromagnetic sealing field in the guide channel, which sealing field seals the guide channel at the bottom and acts laterally against ferromagnetic attraction, is described in EP 0 776 382 B1 without a correction field.

The aforementioned method for strip stabilization is also described in DE 195 35 854 C2. The electromagnetic sealing field operates there as an electromagnetic traveling field. In this regard, a controllable magnetic field superimposed on the modulation of the electromagnetic traveling field is applied in the region of the guide channel, and the field strength and/or frequency of this magnetic field can be adjusted as a function of the position of the strip in the coating channel, which is detected by sensors. However, the device used for this consists of pairs of magnet coils arranged in succession in the direction of strip flow. In addition, other coils are provided around the guide channel. As a result, the pairs of magnet coils, which can be controlled with respect to field strength and/or frequency, must be adapted to different strip materials or strip thicknesses.

However, the method or the device described above cannot be used either for very thin metal strip or for different strip widths.

The objective of the invention is to specify an electromagnetic seal together with a device that compensates lateral ferromagnetic attraction for all presently known magnetic sealing fields.

In accordance with the invention, the stated objective is achieved in such a way that the electromagnetic field of one or more main coils in each inductor generates a sealing field, which is realized as an electromagnetic traveling field, as a blocking field, or as a pump field, and several correction fields are arranged with a distribution that provides a selected configuration, such that the position and number of the correction fields are individually determined at least according to different width levels of the metal strip. The advantages include not only avoidance of the effect of ferromagnetic attraction, but also the possibility of adaptation to a large number of criteria which, in the past, gave rise to center deviations due to ferromagnetic attraction in the guide channel. Examples that might be mentioned are: varied thicknes, and strip waviness, such as center buckles, quarter buckles, crossbows, S-shapes, and the like. However, the main advantage is that a width variation in width levels can already be taken into consideration during the designing of the inductors, i.e., a number of the correction fields and the position of the correction fields are matched to a fixed metal strip width. In this regard, the extent of the magnets can be taken into consideration by selection of the type of sealing by traveling field, blocking-field, or pump field.

In one embodiment, the correction fields are distributed in position and number according to a production program. Different widths of metal strip can be coated by one and the same method.

To allow favorable control of the magnetic fields of the main coil and correction coil, it is also advantageous for the correction fields to be activated by separate pieces of power supply equipment, which are phase-synchronized and time-synchronized with the respective inductor.

In this regard, correction steps of the correction field in relation to the main coil field will proceed more easily if the correction fields are operated with direct current.

Another measure for achieving better control of the main fields is field-strengthening or field-weakening operation of the correction fields locally within the sealing field.

Since the determination of the instantaneous position of the metal strip in the guide channel is a prerequisite for controlling the correction fields, it is further proposed that the lateral position of the metal strip in the guide channel be detected by measuring coils, which perform measurements inside the correction fields and/or outside the correction fields.

An alternative to this is to measure the lateral position of the metal strip in the guide channel continuously by contactless measuring methods, for example, laser beams.

The device for hot dip coating metal strip, especially steel strip, is designed for a metal strip width change in such a way that, at least on two opposing magnet yoke surfaces, each inductor has a sealing field with one or more main coils for an electromagnetic traveling field, a blocking field, or a pump field and with several correction coils distributed in a selected configuration in the magnet yoke surface, whose number and position is determined according to different widths and/or thicknesses of the metal strip.

To this end, the effects of the correction coils on the field of the main coils can be controlled for different strip widths and/or thicknesses by arranging the correction coils at the vertices of a polygon as a function of a production program.

This design is supported by connecting the correction coils to separate power supply sources, which are phase-synchronized and time-synchronized with the respective main coils.

The instantaneous position of the metal strip in the guide channel can also be detected for varying strip flow speeds by providing measuring coils for the determination of the instantaneous strip position in the guide channel inside and/or outside the correction coils.

In general, very exact measurement can be achieved by measuring the lateral position of the metal strip in the guide channel by means of contactless-type measuring instruments.

The correction coils can also be connected to a direct current source.

The drawings illustrate specific embodiments of the invention, which are explained in greater detail below.

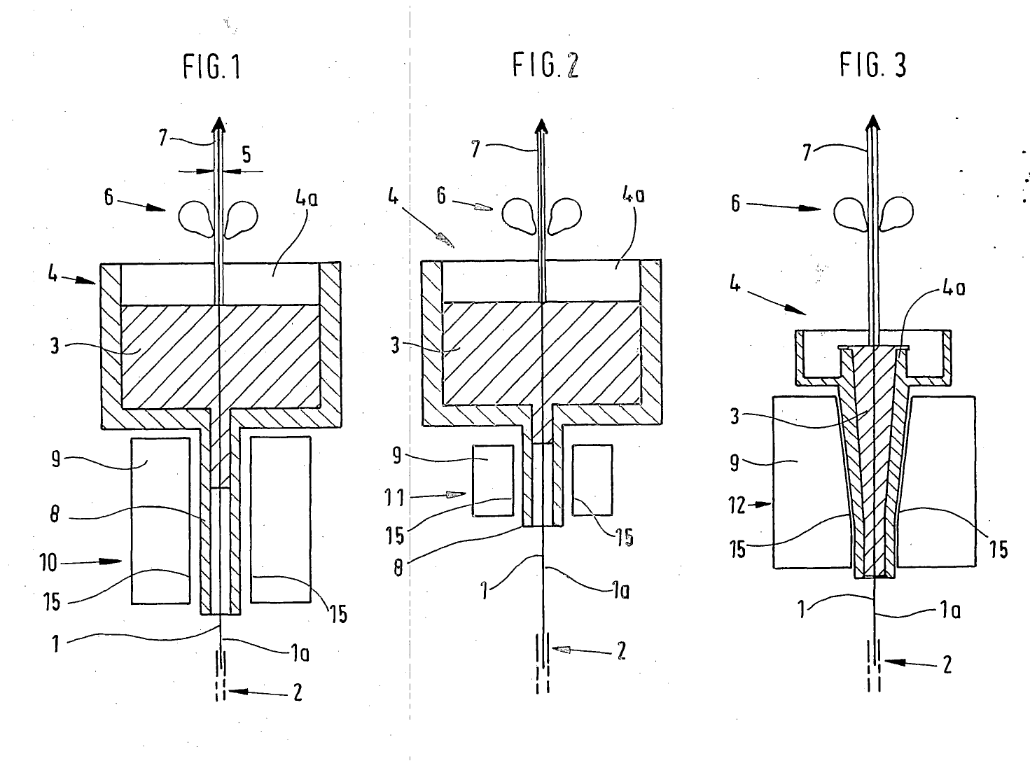

FIG. 1 shows the coating station with the magnet system of the traveling field.

FIG. 2 shows the coating station with the system of the blocking field.

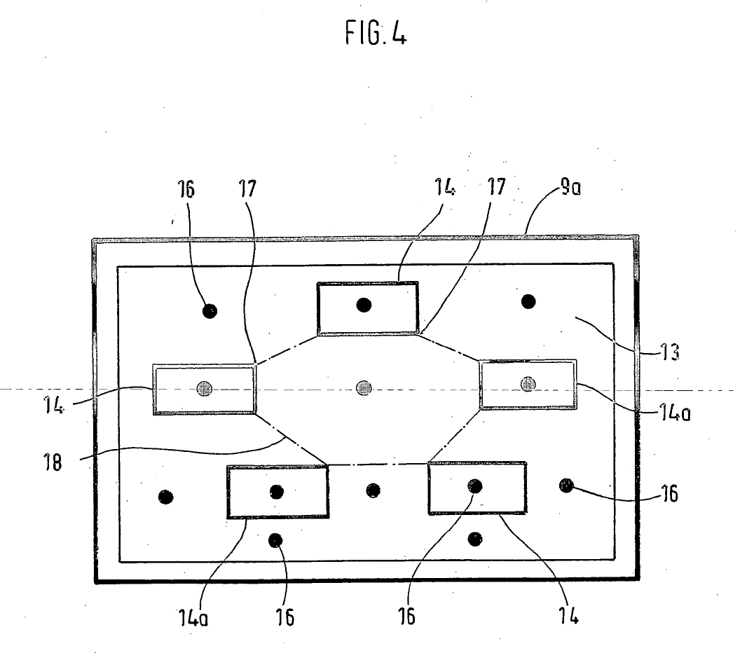

FIG. 3 shows the coating station with the system of the pump field.

FIG. 4 shows a front view of a sealing field with the main coil, the correction coils, and the measuring coils.

In the method for hot dip coating metal strip 1, especially steel strip 1a, the metal strip 1 is guided in a preheated state from a furnace by guide rolls that act as strip guides 2 obliquely or vertically from bottom to top through the molten coating metal 3 into a coating station 4. After the strip has emerged from the coating station 4, the coating thickness 5 is controlled in a stripping system 6.

During the coating with coating metal 3, the relatively thin metal strip 1 has a tendency to vibrate, and, in addition, fluctuations in the strip speed or strip speeds that vary according to the selected dimensions . . . the metal strip 1 is sealed towards the bottom by an electromagnetic sealing field 13 in the guide channel 8 while the coating 7 is still liquid and is guided laterally by a correction field 14, which compensates ferromagnetic attraction.

The constant center position of the metal strip 1 in the guide channel 8 that is strived for constitutes an unstable equilibrium due to the interference between magnetic field inductors 9 from two sides and directions. The sum of the forces of magnetic attraction acting on the metal strip 1 is equal to zero only in the center of the guide channel 8. As soon as the metal strip 1 is deflected from its center position, the distance to the two inductors 9 changes. In this process, the metal strip 1 moves closer to one of the sealing fields 13 and moves farther away from the other. A solution in which the two magnetic fields of the inductors 9 are designed to be so strong that any displacement is excluded as a possibility is out of the question due to the accompanying strong heating of the metal strip 1. The center position of the metal strip 1 is now taken into account, together with other criteria, by the generation of a sealing field 13 in each inductor 9 with a main coil 9a, which sealing field 13 is selected as an electromagnetic traveling field 10 (FIG. 1), as a blocking field 11 (FIG. 2), or as a pump field 12 (FIG. 3). Several correction fields 14 are distributed in a selected configuration (FIG. 4), such that the position and number of the correction fields are individually determined at least according to different width levels of the metal strip 1. According to FIG. 4, the correction coils 14a can be arranged within the magnet yoke surface 15, which is surrounded by the main coil 9a, in the form of a triangle or, as shown in the drawing, in the form of a polygon. In FIG. 4, both horizontal triangular shapes and vertical triangular shapes are formed. The correction coils 14a or the correction fields 14 form the vertices 17 of a polygon, and the polygon 18 can be a triangle, a square, or any n-sided polygon. In this regard, the position and distribution of the correction coils 14a affects their size.

The correction coils 14a or correction fields 14 are distributed in position and number as a function of the selected metal strip width levels analogously to a production program.

The lateral or center position of the metal strip 1 in the guide channel 8 can be continuously measured by contactless measuring devices. The measuring coils 16 are located (FIG. 4) inside or outside the correction coils 14a, so that a measurement pattern over the entire width of the metal strip is obtained. This makes it possible to detect the aforementioned anomalies of metal strip shape or position.

The electromagnetic traveling field 10 or an electromagnetic blocking field 11 or an electromagnetic pump field 12 is selected on the basis of the characteristic values of the material (strength, microstructure) of the metal strip 1.

### LIST OF REFERENCE NUMBERS

1 metal strip
1a steel strip
2 strip guide
3 coating metal
4 coating station
4a reservoir
5 coating thickness
6 stripping system
7 coating
8 guide channel
9 inductor
9a main coil
10 electromagnetic traveling field
11 electromagnetic blocking field
12 electromagnetic pump field
13 sealing field
14 correction field
14a correction coil
15 magnet yoke surface
16 measuring coil
17 vertices of a polygon
18 polygon

1. Method for hot dip coating metal strip (1), especially steel strip (1a), wherein the strip (1) is guided obliquely or vertically from bottom to top through the molten coating metal (3) in a coating station (4), wherein the coating thickness (5) is controlled after the strip (1) has emerged from the coating bath, and wherein the thin metal strip (1), which has a tendency to vibrate, is sealed towards the bottom by an electromagnetic sealing field (13) in the guide channel (8) while the coating (7) is still liquid and at a variable strip speed and is guided laterally by a correction field (14), which compensates ferromagnetic attraction, characterized by the fact that the electromagnetic field (10, 11, 12) of one or more main coils (9a) in each inductor (9) generates a sealing field (13), which is realized as an electromagnetic traveling field (10), as a blocking field (11), or as a pump field (12), and several correction fields (14) are arranged with a distribution that provides a selected configuration, such that the position and number of the correction fields are individually determined at least according to different width levels of the metal strip (1).

2. Method in accordance with claim 1, characterized by the fact that the correction fields (14) are distributed in position and number according to a production program.

3. Method in accordance with claim 1 or claim 2, characterized by the fact that the correction fields (14) are activated by separate pieces of power supply equipment, which are phase-synchronized and time-synchronized with the respective inductor (9).

4. Method in accordance with any of claims 1 to 3, characterized by the fact that the correction fields (14) are operated with direct current.

5. Method in accordance with any of claims 1 to 4, characterized by the fact that the correction fields (14) are locally operated within the sealing field (13) in a field-strengthening or field-weakening way.

6. Method in accordance with any of claims 1 to 5, characterized by the fact that the lateral position of the metal strip (1) in the guide channel (8) is detected by measuring coils (16), which perform measurements inside the correction fields (14) and/or outside the correction fields (14).

7. Method in accordance with any of claims 1 to 5, characterized by the fact that the lateral position of the metal strip (1) in the guide channel (8) is continuously measured by contactless measuring methods.

8. Device for hot dip coating metal strip (1), especially steel strip (1a), with a strip guide (2) that runs obliquely or vertically from bottom to top, with a coating station (4), with a guide channel (8) for the metal strip (1), which guide channel (8) is connected to the reservoir (4a) at the bottom of the coating station (4) and is surrounded by an inductor (9) for sealing at the bottom, with correction coils (14a) for a center position of the metal strip (1) in the guide channel (8), and with a stripping system (6) above the reservoir (4a), characterized by the fact that, at least on two opposing magnet yoke surfaces (15), each inductor (9) has a sealing field (13) with one or more main coils (9a) for an electromagnetic traveling field (10), a blocking field (11), or a pump field (12) and with several correction coils (14a) distributed in a selected configuration in the magnet yoke surface (15), whose number and position is determined according to different widths and/or thicknesses of the metal strip (1).

9. Device in accordance with claim 8, characterized by the fact that the correction coils (14a) are arranged at the vertices (17) of a polygon (18) as a function of a production program.

10. Device in accordance with claim 8 or 9, characterized by the fact that the correction coils (14a) are connected to separate power supply sources, which are phase-synchronized and time-synchronized with the respective main coils (9a).

11. Device in accordance with any of claims 8 to 10, characterized by the fact that measuring coils (16) for the determination of the instantaneous strip position in the guide channel (8) are provided inside and/or outside the correction coils (14a).

12. Device in accordance with any of claims 8 to 10, characterized by the fact that the lateral position of the metal strip (1) in the guide channel (8) is measured by means of measuring instruments that operate without contact.

13. Device in accordance with any of claims 8 to 12, characterized by the fact that the correction coils (14a) are connected to a direct current source.
